(19) United States
(12) Patent Application Publication
(10) Pub. No.: US 2008/0133460 A1
(43) Pub. Date: Jun. 5, 2008

(54) SEARCHING DESCENDANT PAGES OF A ROOT PAGE FOR KEYWORDS

(76) Inventors: Timothy Pressler Clark, Rochester, MN (US); Zachary Adam Garbow, Rochester, MN (US); Richard Michael Theis, Sauk Rapids, MN (US); Brian Paul Wallenfelt, Eden Prairie, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/566,996

(22) Filed: Dec. 5, 2006

(51) Int. Cl. G06F 17/30

(52) U.S. Cl. 707/2; 707/E17.116

(57) ABSTRACT

An identifier of a root page, a keyword, and a depth are received from a client. Descendant pages in paths from the root page are searched. The descendant pages exist in the paths at levels within the depth from the root page. A term in a first descendant page is found that matches the keyword. A child link that points to a child page of the root page is found. A path relevancy for the child link is determined by performing a logical-or operation on page relevancies of each of the descendant pages in a path. A copy of the root page, a descendant link that points at the first descendant page, a match score for the first descendant page, and a path relevancy for the path of the child link are sent to the client. In this way, pages that are linked from root pages may be searched.

### FIELD

An embodiment of the invention generally relates to searching linked pages of information that are stored in computer systems and more specifically relates to searching descendant pages of a root page for keywords.

### BACKGROUND

Years ago, computers were isolated devices that did not communicate with each other. But, today computers are often connected in networks, such as the Internet or World Wide Web, and a user at one computer, often called a client, may wish to access information at multiple other computers, often called servers, via a network. Information is often stored at servers and sent to the clients in units of pages, which are connected together via embedded hyperlinks or links. A link is an address, such as a URL (Uniform Resource Locator) of a linked page that is embedded in a linking page that, when selected, causes the linked page to be retrieved. Because the Internet includes so many pages, finding a page of interest can be difficult, so several companies provide search engines that allow users to search for pages that contain keywords.

Current search engines have strong technology in the area of searching the Internet in general for a combination of keywords and can usually find pages that are close to the desired results and related to the keywords. But, often the found pages are too general and are not the specific page that the user desires. Instead, the specific page is often linked (directly or indirectly) from one of found pages. Unfortunately, the found pages often contain many links and following all of them is tedious and time consuming.

Also, users might not remember the URL of the specific page of interest, but they can recall that they had previously discovered that page by following one of the links from a root page, such as a specific portal. Unfortunately, current search engines typically search all indexed pages for keywords and do not utilize the potentially valuable piece of information that the user knows: the root page that links directly or indirectly to the page of interest.

In an attempt to address these problems, some sites provide their own search functions that allow users to search that particular site for a keyword. But, these search functions are only helpful if the page of interest is stored at that site. If the page of interest is not present at the site, but is instead linked from that site, the search function will not find it.

As another technique, some browsers will search the sites identified in their history caches of sites previously visited. This technique can be successful if the user is at the same computer using the same browser as when the page was previously viewed and if the page has not already been purged from the history cache. But, users are increasingly mobile and may use a variety of computers and browsers, and users are concerned with privacy, so they often erase the history cache, so this technique is of limited usefulness.

Thus, what is needed is an enhanced technique for finding pages that are linked, either directly or indirectly, from root pages.

### SUMMARY

A method, apparatus, system, and signal-bearing medium are provided. In an embodiment, an identifier of a root page, a keyword, and a depth are received from a client. Descendant pages in paths from the root page are searched. The descendant pages exist in the paths at levels that are within the depth from the root page. A term in a first descendant page is found that matches the keyword. A child link that points to a child page of the root page is also found. A path relevancy for the child link is determined by performing a logical-or operation on page relevancies of each of the descendant pages in a path. A copy of the root page, a descendant link that points at the first descendant page, a match score for the first descendant page, and a path relevancy for the path of the child link are sent to the client. In this way, pages that are linked from root pages may be searched.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of example pages, according to an embodiment of the invention.

FIG. 3 depicts a block diagram of an example user interface for initiating search requests, according to an embodiment of the invention.

FIG. 4 depicts a block diagram of an example copy of a root page, according to an embodiment of the invention.

FIG. 5 depicts a block diagram of an example data structure for an index, according to an embodiment of the invention.

FIG. 6 depicts a flowchart of example processing for a crawler, according to an embodiment of the invention.

FIG. 7 depicts a flowchart of example processing for search requests, according to an embodiment of the invention.

FIG. 8 depicts a flowchart of further example processing for search requests, according to an embodiment of the invention.

FIG. 9 depicts a flowchart of example processing for calculating match scores, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment of the invention, a search engine receives a search request from a client. The search request includes a search keyword or keywords, an identifier of a root page, and a depth. The search engine searches descendant pages (via an index) that exist in paths at levels that are within the depth from the root page. The search engine finds a first descendant page of the root page that contains terms that match (are identical to) the keyword(s). The search engine calculates a match score, which represents the degree to which the first descendant page matches the keywords. The search engine also finds a child link that points to a child page of the root page. The search engine determines a path relevancy for the child link by performing a logical-or operation on page relevancies of each of the descendant pages in a path. A page relevancy indicates whether or not the page has a match score that exceeds a match threshold. The search engine sends a copy of the root page, a descendant link that points at the first descendant page, a match score for the first descendant page, and a path relevancy for the path of the child link to the client. In this way, pages that are linked from root pages may be searched.

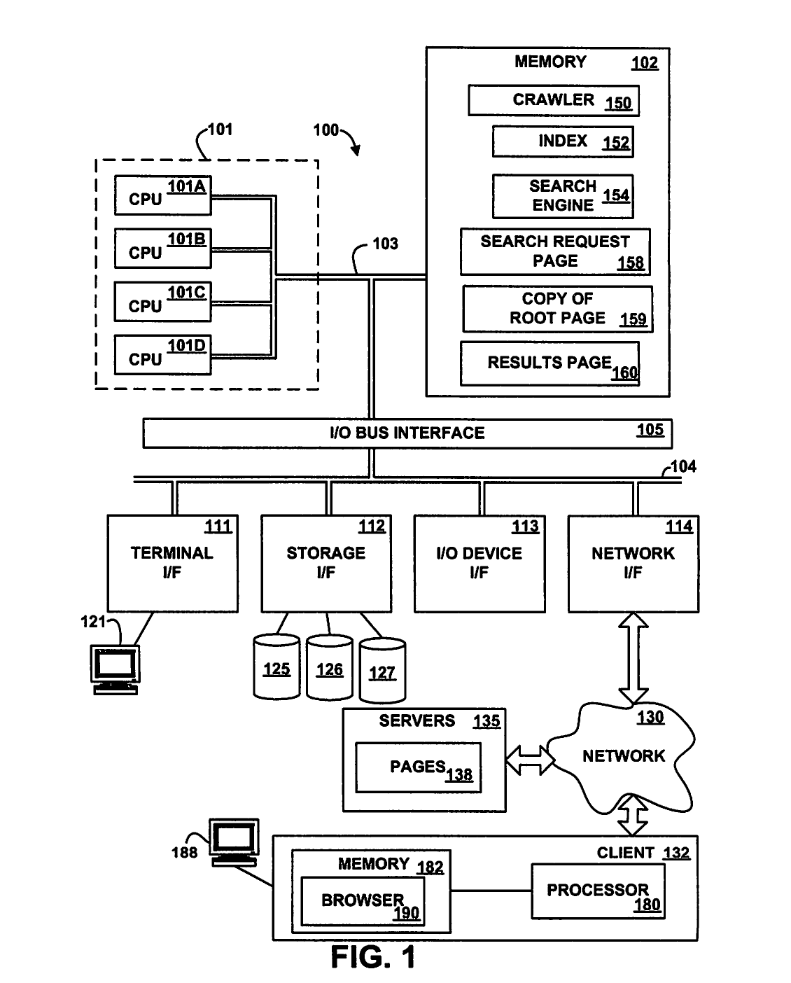

Referring to the Drawings, wherein like numbers denote like parts throughout the several views, FIG. 1 depicts a high-level block diagram representation of a server computer system 100 connected to a client computer system 132 and server computer systems 135 via a network 130, according to an embodiment of the present invention. The terms “client” and “server” are used herein for convenience only, and in various embodiments a computer that operates as a client in one environment may operate as a server in another environment, and vice versa. In an embodiment, the hardware components of the computer systems 100, 132, and 135 may be implemented by IBM System i5 computer systems available from International Business Machines Corporation of Armonk, N.Y. But, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a crawler 150, an index 152, a search engine 154, a search request page 158, a copy 159 of a root page, and a results page 160. Although the crawler 150, the index 152, the search engine 154, the search request page 158, the copy 159 of a root page, and the results page 160 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the crawler 150, the index 152, the search engine 154, the search request page 158, the copy 159 of the root page, and the results page 160 are illustrated as being contained within the main memory 102, these elements are not necessarily all completely contained in the same storage device at the same time. Further, although the crawler 150, the index 152, the search engine 154, the search request page 158, the copy 159 of the root page, and the results page 160 are illustrated as being separate entities, in other embodiments some of them, portions of some of them, or all of them may be packaged together.

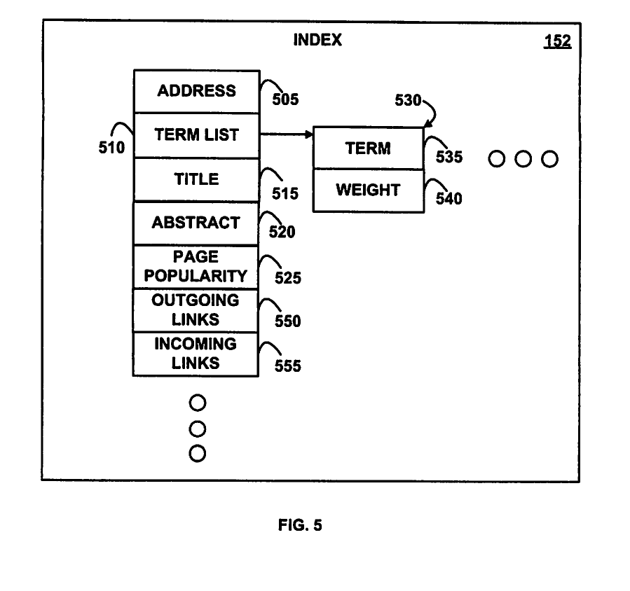

The crawler 150 (also called a spider, robot, or agent) visits a page at the server 135, reads it, and then follows links to other pages within the web site. The crawler 150 typically returns to the site on a regular basis, such as every month or two, to look for changes. The crawler 150 stores selected information it finds in the index 152, which represents the pages 138 at the server computer systems 135. The index 152 is further described below with reference to FIG. 5. Sometimes new pages or changes that the crawler 150 finds may take some time to be added to the index 152. Thus, a web page may have been “crawled” but not yet “indexed.” Until the page has been added to the index 152, the page is not available to those searching with the search engine 154.

The search engine 154 receives an identifier of one of the pages 138 (a root page), a search keyword, and a depth from the client computer system 132 via the search request page 158. The search engine 154 reads information about the pages 138 that are described in the pre-created index 152 to find descendant pages that include terms that match the keywords. The descendant pages that the search engine 154 finds are descendants of the root page at a level from the root page that is within the depth. The search engine 154 returns a copy 159 of the root page with indications of the relevancy of the embedded links in the root page to the keywords. The search engine 154 may also return the optional results page 160 to the client computer system 132.

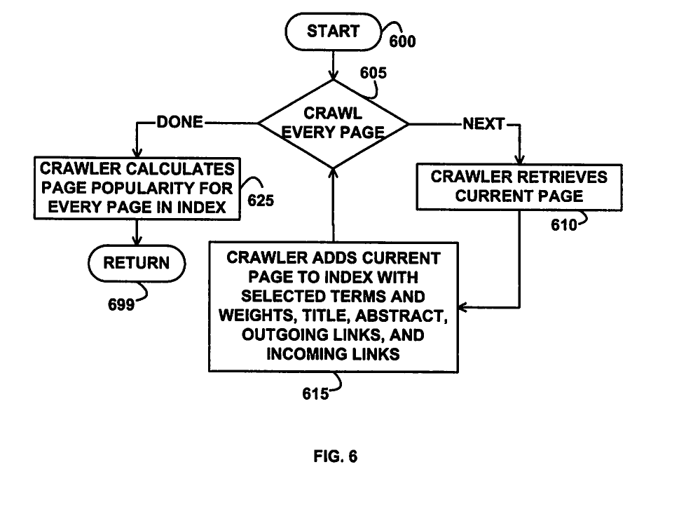

In an embodiment, the crawler 150 and/or the search engine 154 include instructions capable of executing on the processor 101 or statements capable of being interpreted by instructions executing on the processor 101 to perform the functions as further described below with reference to FIGS. 6, 7, 8, and 9. In another embodiment, the crawler 150 and/or the search engine 154 may be implemented in microcode. In another embodiment, the crawler 150 and/or the search engine 154 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, which may include user output devices (such as a video display device or speaker) and user input devices (such as a keyboard, mouse, or other pointing device). The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the client computer system 132, and the server computer systems 135. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client computer system 132 may include some or all of the hardware components previously described above as being included in the server computer system 100. The client computer system 132 is connected to a user terminal 188. The client computer system 132 includes memory 182 connected to a processor 180. The memory 182 stores or encodes a browser 190, which may include instructions executable on the processor 180. The browser 190 receives the search request page 158 from the search engine 154, presents the search request page 158 via the terminal 188, receives a search request via the terminal 188 and sends the search request to the search engine 154. In various embodiments, the browser 190 may be implemented via an operating system, a user application, a third-party application, or any appropriate program encoded with executable instructions or interpretable statements for execution on the process 180. In another embodiment, the browser 190 may implemented in hardware.

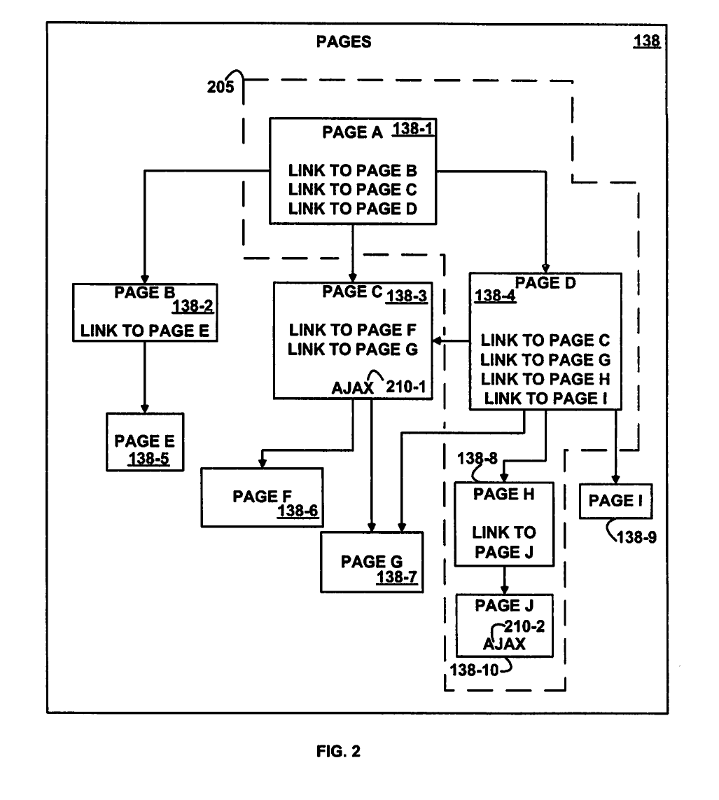

The server computer systems 135 may include some or all of the hardware components previously described above as being included in the computer system 100. The server computer systems 135 include pages 138 stored in memory with a similar description as the main memory 102. The pages 138 may include any appropriate content that is capable of being crawled via the crawler 150 and retrieved via the browser 190. In various embodiments, the pages 138 may be implemented via documents, files, objects, tables, databases, directories, subdirectories, or any portion or combination thereof and in some embodiments may include embedded control tags, statements, or logic in addition to data. Examples of the page 138 are further described below with reference to FIG. 2.

It should be understood that FIG. 1 is intended to depict the representative major components of the computer system 100, the network 130, the client computer system 132, and the server computer systems 135 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the server computer system 100 and/or the client computer system 132, and that, when read and executed by one or more processors in the server computer system 100 and/or the client computer system 132, cause the server computer system 100 and/or the client computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server computer system 100 and/or the client computer system 132 via a variety of tangible signal-bearing media that may be operatively or communicatively connected (directly or indirectly) to the processor or processors, such as the processor 101 and 180. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102 or 182, CD-RW, or diskette; or

(3) information conveyed to the computer system 100 and/or the client computer system 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of example pages 138, according to an embodiment of the invention. The example pages 138 includes pages 138-1, 138-2, 138-3, 138-4, 138-5, 138-6, 138-7, 138-8, 138-9, and 138-10, whose organization may be represented as a graph. The page 138 generically refers to the pages 138-1, 138-2, 138-3, 138-4, 138-5, 138-6, 138-7, 138-8, 138-9, and/or 138-10.

In general, a graph includes sets of node and edges. The nodes (also called vertices) represent objects or data, and the edges represent the links between the pages. An edge connects two nodes, and these two nodes are referred to as incident to that edge; equivalently, that edge is incident to those two nodes. The edges may have a direction, in which case the edges are called directed edges. If a direction of an edge is away from a first node and toward a second node, the first node is said to be the parent node of the second node, which is the child node of the first node.

One type of a graph is a tree, which represents a hierarchical organization of linked data. A tree takes its name from an analogy to trees in nature, which have a hierarchical organization of branches and leaves. For example, a leaf is connected to a small branch, which further is connected to a large branch, and all branches of the tree have a common starting point at the root. Analogously, in an embodiment where the graph is a tree, the nodes have a hierarchical organization, in that a node has a relationship with another node, which itself may have a further relationship with other nodes, and so on. Thus, all of the nodes can be divided up into sub-groups and groups that ultimately all have a relationship to a root node.

To define a tree more formally, a tree structure defines the hierarchical organization of nodes, which can represent any data. Hence, a tree is a finite set, T, of one or more of the nodes, such that

a) one specially designated node is called the root of the tree; and

b) the remaining nodes (excluding the root) are partitioned into m>=0 disjoint sets T₁, . . . Tₘ, and each of these sets is in turn a tree.

The trees T₁, . . . , Tₘ are called the subtrees of the root. Thus, every node in a tree is the root of some subtree contained in the whole tree. The number of subtrees of a node is called the degree of that node. A node of degree zero is called a terminal node or a leaf. A non-terminal node is called a branch node. The level of a node with respect to T is defined by saying that the root has level 0, and other nodes have a level that is one higher than they have with respect to the subtree that contains them. Each root is the parent of the roots of its subtrees, and the latter are siblings, and they are also the children of their parent. The nodes in the subtrees of a root are the root's descendants. The root of the entire tree has no parent.

A different definition of a tree defines a tree as a connected acyclic simple graph. A simple graph has no multiple edges that share the same end nodes. An acyclic graph contains no cycles, where a cycle is a closed walk.

A walk is an alternating sequence of a subset of the nodes and edges of the graph, beginning with a first-node and ending with a last-node, in which each node in the walk is incident to the two edges that precede and follow it in the sequence, and the nodes that precede and follow an edge are the end-nodes of that edge. The walk is said to be closed if its first-node and last-node are the same or open if its first-node and last-node are different. An open walk is also called a path. In various embodiments, all of the edges in the walk may be different or distinct (in which case the walk is also known as a trail), or some of the edges in the walk may be the same. A walk may be formed from any type of the graph.

Thus, in the example of FIG. 2, the organization of the linked pages 138 may be represented by a graph, in which case the nodes may represent the pages, and each directed edge represents a link (an embedded partially or fully-qualified URL or address) from one page to another page.

For example, the page 138-1 is the root page of the pages 138. The page 138-1 includes embedded links (child links) that point to its child pages 138-2, 138-3, and 138-4. The pages 138-2, 138-3, and 138-4 are descendants of their parent page, which is the root page 138-1. The page 138-2 includes an embedded child link that points at its child page 138-5. A URL (Uniform Resource Locator) is an example of a link, but in other embodiments any appropriate address or identifier may be used. The page 138-5 is a descendant of its parent page 138-2 and of the page 138-1.

The page 138-3 includes embedded child links that point to its child pages 138-6 and 138-7. The pages 138-6 and 138-7 are descendants of their parent page 138-3 and of the page 138-1. The page 138-4 includes embedded child links that point to its child pages 138-3, 138-7, 138-8, and 138-9. The pages 138-3, 138-7, 138-8, and 138-9 are descendants of their parent page 138-4 and of the page 138-1. The page 138-8 includes an embedded child link that points at its child page 138-10. The page 138-10 is a descendant of its parent page 138-8, the page 138-4, and of the page 138-1.

The page 138-3 includes the term 210-1, and the page 138-10 includes the term 210-2. Any, some, or all of the pages may also include additional terms.

The graph of the pages 138 includes an example path 205, which is a sequence of the page 138-1, the embedded child link from the page 138-1 to the page 138-4, the page 138-4, the embedded child link from the page 138-4 to the page 138-8, the page 138-8, the embedded child link from the page 138-8 to the page 138-10, and the page 138-10. The pages 138-4, 138-8, and 138-10 in the path 205 are descendant pages of the root page 138-1. The path 205 represents a way for a user that is viewing the page 138-1 to find the descendant page 138-10 that includes a term 210-2 that matches or is the same as a search keyword supplied by the user. The root page 138-1 is at level zero in the path 205. The page 138-4 is at level one in the path 205. The page 138-8 is at level two in the path 205. The page 138-10 is at level three in the path 205.

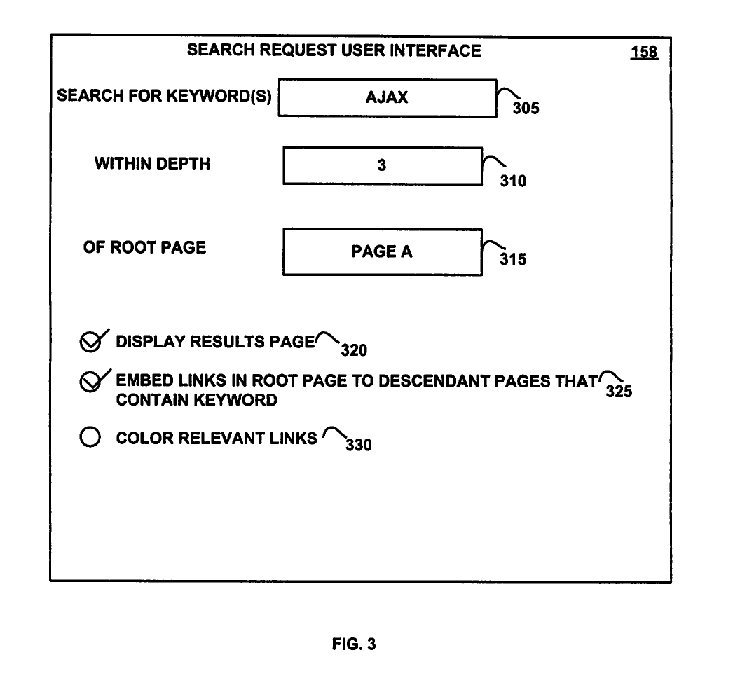

FIG. 3 depicts a block diagram of an example user interface 158 for initiating search requests, according to an embodiment of the invention. The browser 190 may retrieve the search request user interface page 158 from the server computer system 100, display or present the search request page 158 via the terminal 188, receive data from the user via the terminal 188 via input fields or widgets in the search request page 158, and send the data to the search engine 154 as a request for a search.

The search request page 158 includes input fields 305, 310, and 315 and options 320, 325, and 330. The input field 305 allows the user to input a search keyword. The input field 310 allows the user to input a depth 310. The input field 315 allows the user to specify a name, address, identifier, or URL of a root page. The browser 190 sends a search request to the search engine 154 that requests the search engine 154 to search for the keywords 305 in pages that are at levels along paths (e.g., the path 205) from the root page 315, where the levels are within (less than or equal to) the depth 310. Thus, the depth 310 specifies a maximum level from the root page 315 at which the browser 190 requests the search engine 154 to search.

The display results option 320 allows the specification of a request that instructs the search engine 154 to add descendant links that point at found descendant pages to the results page 160. The embed option 325 allows the specification of a request that instructs the search engine 154 to add links that point at the found descendant pages to a copy of the root page 315. The color option 330 allows the specification of a request that instructs the search engine 154 to highlight or add a color to the child links in the root page 315 that point, directly or indirectly, to descendant pages that contain terms that match the keywords 305.

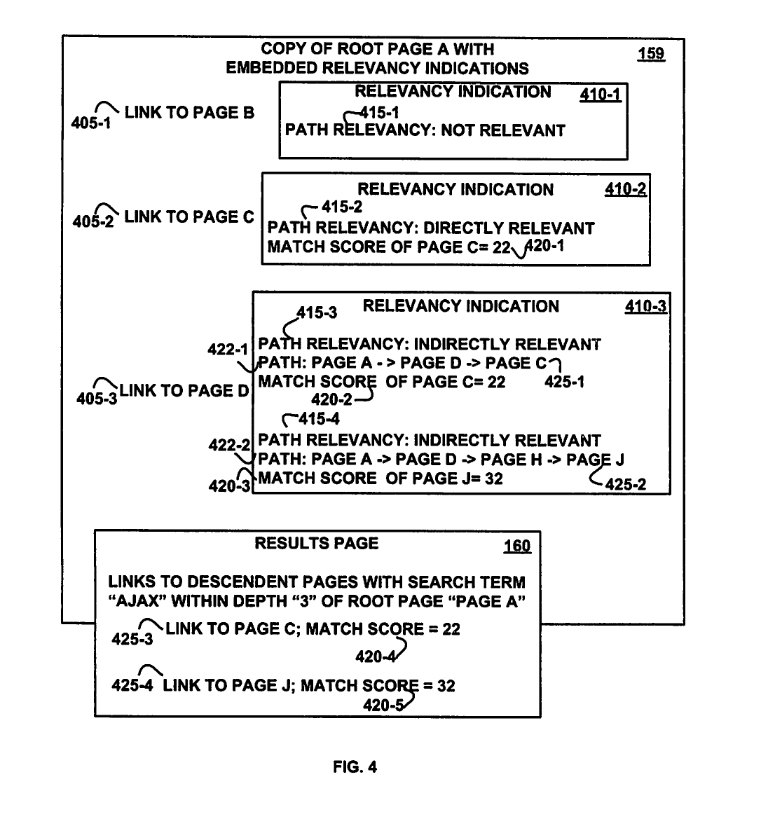

FIG. 4 depicts a block diagram of an example copy 159 of a root page, according to an embodiment of the invention. The user specifies a root page 315 via the search request page 158 (FIG. 3). The search engine 154 finds the root page 138-1 (FIG. 2), which is identified by the root page 315. The search engine 154 then creates a copy 159 of the root page 138-1 and embeds the relevancy indications 410-1, 410-2, and 410-3 (if specified by the option 325) into the copy 159 of the root page. The copy 159 is thus a copy of the root page 138-1 that includes the relevancy indications 410-1, 410-2, and 410-3. If specified by the color option 330, the search engine 154 also adds color tags to the copy 159 that when read and rendered by the browser 190 cause the links 405-1, 405-2, and 405-3 to be displayed with a color or highlight that corresponds to the relevancy of the path (e.g., the path 205) of which the link 405-1, 405-2, or 405-3 is a part. The search engine 154 may add the color tags in addition to or in lieu of the relevancy indications 410-1, 410-2, and/or 410-3. The search engine 154 sends the copy 159 to the browser 190, which renders and displays the copy 159 via the terminal 188.

The search engine 154 may also create the results page 160 (if specified by the option 320) and send the results page 160 to the browser 190, which renders and displays the results page 160 via the terminal 188.

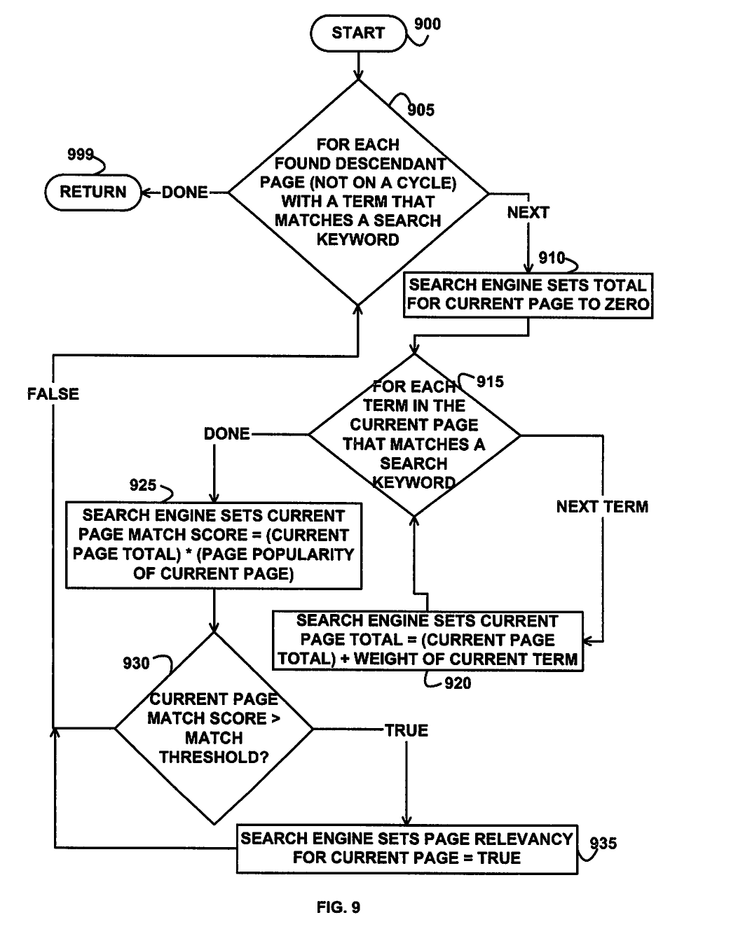

The copy 159 of the root page includes the embedded child links 405-1, 405-2, and 405-3, which point to (contain the address of) the respective child pages 138-2, 138-3, and 138-4 (FIG. 2). The copy 159 of the root page further includes relevancy indications 410-1, 410-2, and 410-3, which are associated with and represent the relevancy of their respective child links 405-1, 405-2, and 405-3. The relevancy indication 410-1 includes a path relevancy indication 415-1, which indicates that the associated link 405-1 is not relevant to the search request 158, meaning that the descendant pages that exist in the path (of which the link 405-1 is a part) within the depth 310 do not contain terms that match the search keywords 305. In the example of FIG. 2, the descendant pages are the page 138-2 and the page 138-5, which do not contain the terms 210-1 and 210-2. Terms match a search keyword 305 if a match score that the search engine 154 calculates is greater than a match threshold, as further described below with reference to FIG. 9. In another embodiment, the copy 159 does not include the relevancy indication 410-1 since the child link 405-1 is not relevant. In another information the link 405-1 is presented or displayed with a color that is assigned to the path relevancy 415-1 value of not relevant.

The relevancy indication 410-2 includes a path relevancy indication 415-2, which indicates that the associated link 405-2 is directly relevant to the search request 158, meaning that the descendant page to which the child link 405-2 directly points does contain terms that match the search keywords 305. In the example of FIG. 2, the descendant page to which the associated link 405-2 directly points is the child page 138-2, which includes the term 210-1, which matches the search keyword 305. The relevancy indication 410-2 further includes a match score 420-1, which is a value that the search engine 154 calculated, in order to determine whether the child page 138-3 is relevant to the search request, i.e., to determine whether the search keywords 305 match the terms 210-1. In an embodiment, the greater the match score, the greater the relevancy of the page to the search keywords 305, or the greater the page matches the search keywords 305. In an embodiment, the less the match score, the less the relevancy of the page to the search keywords 305, or the less the page matches the search keywords 305. Calculation of the match score is further described below with reference to FIG. 9.

The relevancy indication 410-3 includes a path relevancy indication 415-3, which indicates that the associated link 405-3 and its path 422-1 are indirectly relevant to the search request 158, meaning that the descendant page (138-3) to which the child link 405-3 indirectly points (along the path 422-1) does contain term 210-1, which matches the search keyword 305. The relevancy indication 410-3 further includes a match score 420-2, which is a value that the search engine 154 calculated, in order to determine whether the child page 138-3 is relevant to the search request, i.e., to determine whether the search keyword 305 matches the term 210-1. The relevancy indication 410-3 further includes a direct descendant link 425-1 to the page 138-3 that includes the term 210-1 that matches the search keyword 305. In response to the user selecting the direct descendant link 425-1 via the terminal 188 (e.g., via a mouse or keyboard), the browser 190 sends a request to the server computer system 135 to retrieve the page 138-3, which allows the user to view the page 138-3 without needing to follow the multiple links through the described path 422-1. The path 422-1 in the relevancy indication 410-3 describes a path that includes an alternating sequence of pages 138 and links.

The relevancy indication 410-3 further includes a path relevancy indication 415-4, which indicates that the associated link 405-3 and its path 422-2 are indirectly relevant to the search request 158, meaning that the descendant page (138-10 to which the child link 405-3 indirectly points (along the path 422-2) does contain the term 210-2, which matches the search keyword 305. The relevancy indication 410-3 further includes a match score 420-3, which is a value that the search engine 154 calculated, in order to determine whether the child page 138-10 is relevant to the search request, i.e., to determine whether the search keyword 305 matches the term 210-2. The relevancy indication 410-3 further includes a direct descendant link 425-2 to the page 138-10 that includes the term 210-2 that matches the search keyword 305. In response to the user selecting the direct descendant link 425-2 via the terminal 188 (e.g., via a mouse or keyboard), the browser 190 sends a request to the server computer system 135 to retrieve the page 138-10, which allows the user to view the page 138-10 without needing to follow the multiple links through the described path 422-2. The path 422-2 describes the path 205 (FIG. 2), which includes an alternating sequence of pages and links.

The results page 160 is an alternative user interface page that includes direct descendant links 425-3 and 425-4 to the respective descendant pages 138-3 and 138-10 in the paths of the root page 315 and the respective match scores 420-4 and 420-5.

Note that the direct descendant links 425-1, 425-2, 425-3, and 425-4 to the descendant pages 138-3 and 138-10 are present in the relevancy indication 410-3 and the results page 160, but were not present in the original root page 138-1, from which the copy 159 was made. Note that the relevancy indications 410-1, 410-2 and 410-3 are present in the copy 159, but were not present in the original root page 138-1.

FIG. 5 depicts a block diagram of an example data structure for an index 152, according to an embodiment of the invention. The crawler 150 creates the index 152, as further described below with reference to FIG. 6. The index 152 includes an address 505, a term list 510, a title 515, an abstract 520, a page popularity 525, outgoing links 550, and incoming links 555 for each page 138.

The address 505 includes the URL or other address of the page 138 at the servers 135. The term list 510 includes a list of term entries 530 for each term in the page 138 identified by the address 505. Each term entry 530 includes a term 535 and a term weight 540. The term 535 includes a word or collections of words in the page 138. The weight 540 indicates the relative weight, significance, or importance of the associated term 535, as compared to other terms 535 in the term list 530, which represent other words in the page identified by the address 505.

The crawler 150 may determine the weight 540 based on the location on the page (pointed to by the address 505) of the weight's associated term 535 and/or the frequency that the associated term 535 appears on the page 138. For example, the crawler 150 may assign a higher weight to terms that appear in a title or header because the crawler 150 assumes that terms in the title or header are more relevant or more important than terms appearing in other locations in the page. Further, the crawler 150 may also assign a higher weight to terms that appear near the top of the page, such as in the headline or in the first few paragraphs text because the crawler 150 assumes that any page relevant to the topic will mention those words at the beginning. Further, the crawler 150 may also assign a higher weight to terms that appear in a larger font size than terms that appear in a smaller font size because the crawler 150 assumes that terms displayed in a larger font are more important than terms displayed in a smaller font. The crawler 150 may also assign a higher weight to terms that appear in a meta tag. The crawler 150 may also analyze how often terms appear in relation to other words in the web page and assign a higher weight to those terms 535 that appear more frequently.

The title 515 and the abstract 520 may be any text, audio, video, or image that describe the page at the associated address 505. In another embodiment, the index 152 may include any portion or all of the page pointed to by the address 505 The page popularity 525 indicates a relative importance of the page 138 at the address 505, as compared to other of the pages described by the index 152.

The outgoing links 550 specify the child links that are embedded in the page at the address 505 that point to the child pages of the page at the address 505. The incoming links 555 specify the parent page(s) of the page at the address 505 that include links that that point to the page at the address 505.

FIG. 6 depicts a flowchart of example processing for a crawler 150, according to an embodiment of the invention. The processing of FIG. 6 is performed periodically, so that the crawler 150 may crawl and process any pages 138 that have been added or modified since the last time that the crawler 150 crawled the pages 138.

Control begins at block 600. Control then continues to block 605 where the crawler 150 enters a loop that is executed once for each page 138. The crawler 150 may crawl all pages 138 or a subset of the pages 138. So long as more pages 138 remain to be crawled by the logic of FIG. 6, control continues from block 605 to block 610 where the crawler 150 retrieves the current page 138 from a server computer system 135.

Control then continues to block 615 where the crawler 150 adds the current page 138 to the index 152. Adding the current page 138 to the index 152 includes storing the address for the current page 138 in the address 505, selecting and storing the terms that exist in the current page 138 into the terms 535 of the index 152, calculating and storing the weights 540 for the selected terms in the index 152, and finding and storing the outgoing links 550 (embedded child links in the page) and the incoming links 555 to the page.

The crawler 150 may use any appropriate technique for selecting the terms 535 and the weights 540. For example, in an embodiment the crawler 150 may choose to ignore short, common words in the page 138 (e.g., “a” “and,” and “the”), and not store these words in the terms 535. In an embodiment, the crawler 150 may select the weights 540 based on the location and/or frequency of the selected terms 535 in the current page 138. For example, the crawler 150 may assign higher weights 540 to those selected terms 535 that are in the title portion of the page 138 and assign lower weights 540 to those terms 535 that are at the bottom of the page 138. In an embodiment, the crawler 150 may assign higher weights 540 to those terms 535 that are used more frequently in the page 138 while assigning lower weights 540 to those terms 535 that are used less frequently in the page 138. In an embodiment, the crawler 150 may assign higher weights 540 to those terms 535 that have a larger font size in the page 138 while assigning lower weights 540 to those terms 535 that have a smaller font size in the page 138. In an embodiment, the crawler 150 may assign higher weights 540 to those terms 535 that are within meta tags while assigning lower weights 540 to those terms 535 that are not within meta tags in the page 138.

In various embodiments, the crawler 150 may find terms in the page 138 via closed caption tags, transcripts, and voice recognition techniques for analyzing audio or audio with video. But, in other embodiments, the crawler 150 may used any appropriate technique for selecting the terms from the page 138 to store in the terms 535 and for selecting the weights 540 for those terms 535.

Control then returns to block 605 where the crawler 150 determines whether another page still exists to be crawled, as previously described above.

If the crawler 150 has crawled every page 138 or every page in a subset of the pages 138, then control continues from block 605 to block 625 where the crawler 150 calculates the page popularities 525 for every page 138 in the index 152. In an embodiment, the crawler 150 may use either or both of on-the-page criteria or off-the-page criteria to determine the page popularities 525. On-the-page popularity criteria may include the relative weights 540 of the terms 535.

Off-the-page popularity criteria use data external to the page itself. An example of an off-the-page popularity criteria is link analysis, in which the crawler 150 analyzes how pages link to each other to determine the relative importance of the page with respect to other pages. For example, the crawler 150 may assign a higher page popularity 525 to a page with many incoming links 555 (a page to which many other pages link because such a page is probably an important page). In addition, the crawler 150 may use recursive page-popularity where the page popularity of the pages that link to the linked-to page also factor into the popularity of the linked-to page. Page popularity is a numeric value that represents how important a page is, as compared to all other pages described in the index 152. Page popularity 525 is based on the idea that when one page links to another page, it is effectively casting a vote for the other page. The more votes that are cast for a page, the more important the page. Also, in an embodiment, the importance of the page that is casting the vote determines how important the vote itself is.

Control then continues to block 699 where the logic of FIG. 6 returns.

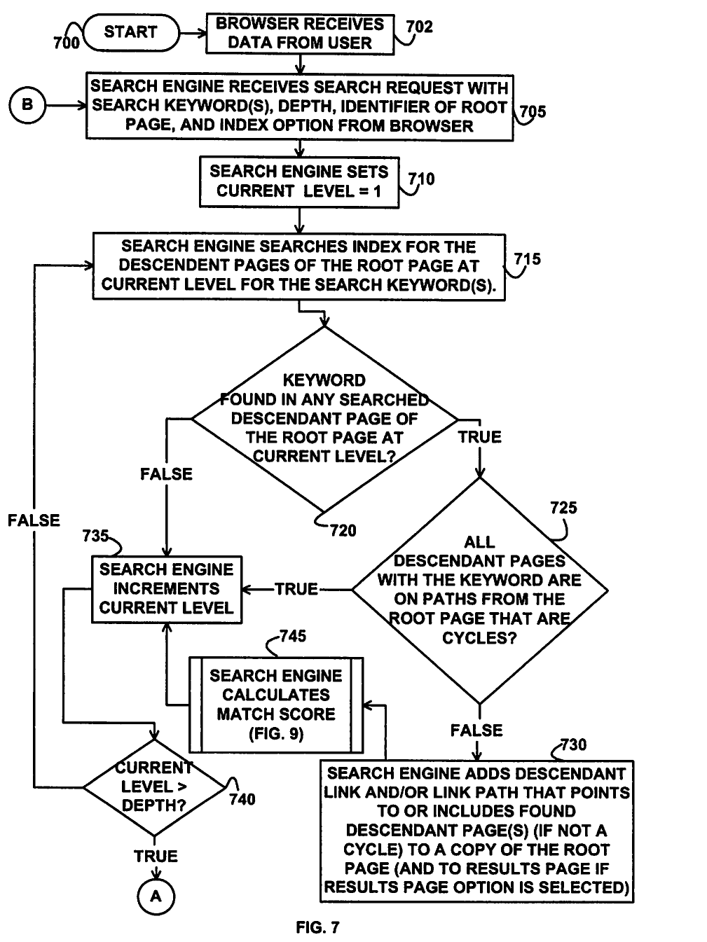

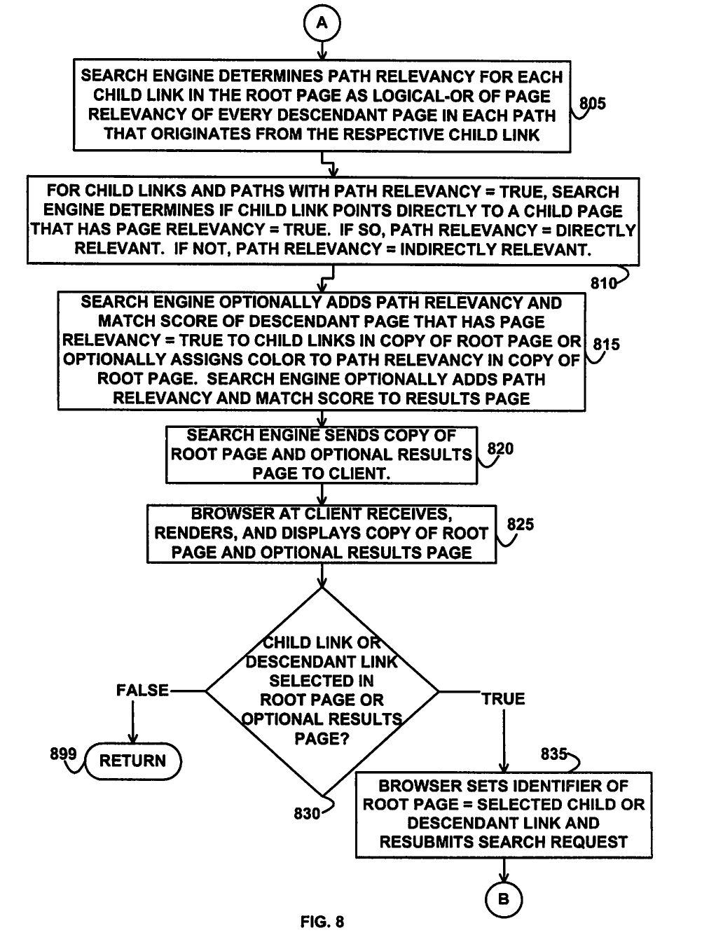

FIGS. 7 and 8 depict flowcharts of example processing for search requests, according to an embodiment of the invention. Control begins at block 700. Control then continues to block 702 where the search engine 154 receives a request for the search request page 158 from the browser 190. In response to the request, the search engine 154 sends the search request page 158 to the browser 190. The browser 190 displays the search request page 158 via the terminal 188 and receives data from the user via the terminal 188, such as the search keywords 305, the depth 310, the root page identifier 315, and an search option 320, 325, and/or 330.

Control then continues to block 705 where the browser 190 sends a search request with the received data to the search engine 154, and the search engine 154 receives the search request with at least one search keyword 305, a depth 310 value, an identifier of a root page 315, and an optional index option from the browser 190 at the client computer system 132.

Control then continues to block 710 where the search engine 154 sets the current level to be one, representing the first level from the root page 315. In an embodiment, the current level is the level at which the search engine 154 is currently searching along paths from the root page 315, but in other embodiments any appropriate search technique and level tracking mechanism may be used. Control then continues to block 715 where the logic of FIG. 7 enters a loop that executes once for each level away from the root page 315, up to the depth 310 (the maximum level to be searched). At block 715, the search engine 154 searches the index 152 for the descendant pages of the root page 315 that are located at the current level from the root page 315 for the search keyword 305.

If the current level is equal to one, then the search engine 154 finds the child links in the root page 315 and then finds the addresses 505 in the index 152 that match the addresses of the child links. The terms 535 associated with the found address 505 that match the child links of the root page 315 are the terms in the child page (the descendant pages at level one). If the current level is greater than one, then the search engine 154 follows the outgoing links 550 associated with the root page's address 505, in order to find the descendant pages in the index 152 at level two. The search engine 154 repeats this process in order to find descendant pages at additional levels.

Control then continues to block 720 where the search engine 154 determines whether the search keyword 305 is found in any descendant page of the root page 315 at the current level by determining if any term 535 in the index 152 associated with an address 505 of a descendant page is the same as (matches) the search keyword 305.

If the determination at block 720 is true, then a page that is described in the index 152 and exists at the current level contains a term 535 that matches (is equal to) one of the received search keywords 305, so control continues to block 725 where the search engine 154 determines whether all descendant pages at the current level that contain a term that matches the keyword are on paths (e.g., the path 205) from the root page 315 that are cycles.

If the determination at block 725 is true, then all descendant pages at the current level that contain a term that matches the keyword are on paths from the root page 315 that are cycles, so control continues to block 735 where the search engine 154 increments the current level by one. Control then continues to block 740 where the search engine 154 determines whether the current level is greater than the depth 310 (the maximum level away from the root page at which the search engine is to search).

If the determination at block 740 is true, then the current level is greater than the depth 310, so all levels that are within the depth 310 away from the root page 315 have been searched by the logic of FIG. 7. Thus, no more pages need to be searched, and the search engine 154 stops searching the pages. Control then continues to block 805 (FIG. 8) where the search engine 154 determines the path relevancy for each child link in the root page 315. The search engine 154 sets the path relevancy for a child link to be the result of a logical-or operation of all of the page relevancies of all descendant pages in all paths from the child link for all descendant pages that exist at all levels that are within (less than or equal to) the depth 310. In another embodiment, the search engine 154 sets the path relevancy for a child link on a per-path basis; that is, the search engine 154 calculates a separate path relevancy for the child link for each path that originates from the child link, as a child link may be a part of multiple paths. (For example, the child link 405-3 is a part of multiple paths 422-1 and 422-2, which are illustrated in FIG. 4 with separate path relevancies 415-3 and 415-4.) The logical-or operation sets the path relevancy to be true if one or more of the page relevancies that are input to the logical-operation are true; otherwise, the logical-or operation sets the path relevancy to be false.

Control then continues to block 810 where the search engine 154 determines if any child link embedded in the root page 315 with a path relevancy of true points directly to a child page with a page relevancy of true. For those child links with a path relevancy of true that point directly to a child page with a page relevancy of true, the search engine 154 changes the path relevancy to indicate that the child link is directly relevant because the child page pointed to by the child link is a descendant page that includes a term 535 that matches the search keyword 305, and the match score for the descendant page is greater than the match threshold. For those child links embedded in the root page 315 that do not point directly to a child page with a page relevancy of true, but that point to a page in a path that includes a descendant page within the depth 310 that has a page relevancy of true, the search engine 154 sets the path relevancy to indicate that the child link is indirectly relevant because the child page pointed to by the child link is different from the descendant page that includes the term 535 that matches the search keyword 305.

Control then continues to block 815 where the search engine 154 adds the path relevancy (e.g., the path relevancy 415-2, 415-3, and 415-4) and the match score (e.g., the match score 420-1, 420-2, and 420-3) of the descendant page that has a page relevancy of true into the copy 159 of the root page 315 if the embed option 325 is selected. The search engine 154 also adds the path relevancy and the match score of the descendant page that has a page relevancy of true into the results page 160 if the display results option 320 was selected. The search engine 154 associates the path relevancy and match score with their child link, e.g., by placing the path relevancy and match score connected to or adjacent the child link whose relevancy they describe.

Control then continues to block 820 where the search engine 154 sends the copy 159 of the root page 315 and the optional results page 160 to the client computer system 132. Control then continues to block 825 where the browser 190 at the client computer system 132 receives, renders, and displays the copy 159 of the root page 315 and the optional results page 160 via the terminal 188.

Control then continues to block 830 where the browser 190 determines whether the user has selected (via the terminal 188) a child link (e.g., the child link 405-1, 405-2, or 405-3) or a descendant link (e.g., the descendant link 425-1, 425-2, 425-3, or 425-4) in the copy 159 of root page 315 or the results page 160.

If the determination at block 830 is true, then the user selected a child link or a descendant link in the copy 159 of the root page or the results page 160, so control continues to block 835 where the browser 190 sets the identifier of the root page 315 to be the selected child or descendant link and resubmits the search request to the search engine, including the selected child or descendant link as the root page 315, the previously-submitted keyword(s) 305, the previously-submitted depth 310, and the previously-submitted options 320, 325, or 330. Control then returns to block 705 of FIG. 7 where the search engine receives the search request with the new root page, as previously described above.

If the determination at block 830 is false, then a child link or a descendant link was not selected, so control continues to block 899 where the logic of FIGS. 7 and 8 return. In an embodiment, the processing of blocks 830 and 835 is optional.

Referring again to FIG. 7, if the determination at block 740 is false, then the current level is not greater than the depth 310 and more levels within the depth 310 from the root page 315 remain to be searched, so control returns to block 715 where the search engine 154 continues the search at the new current level, as previously described above.

If the determination at block 725 is false, then at least one descendant page at the current level exists that includes a term 535 that matches the keyword, and the at least one descendant page exists on a path (e.g., the path 205) from the root page (the root page 138-1 and 315) that is not a cycle, so control continues to block 730 where the search engine 154 adds a link that points at the found descendant pages (that contain the keyword and are on paths that are not cycles) to the copy 159 of the root page if the embed option 325 is selected. The search engine adds the link 425-3 or 425-4 that points at the found descendant pages into the results page 160 if the display results page option 320 is selected.

Control then continues to block 745 where the search engine 154 calculates the match score for the at least one descendant page, as further described below with reference to FIG. 9. Control then continues to block 735, as previously described above.

If the determination at block 720 is false, then all pages that are described in the index 152 as existing at the current level from the root page 315 along a path (e.g., the path 205) do not include terms 535 that match the search keywords 305, so control continues to block 735, as previously described above.

FIG. 9 depicts a flowchart of example processing for calculating match scores, according to an embodiment of the invention. Control begins at block 900. Control then continues to block 905 where the logic of FIG. 9 starts a loop that executes once for each found descendant page (the descendant page is a descendant of the root page) that is not on a cycle and that has a term 535 in the index 152 that matches a search keyword 305. So long as the determination at block 905 is true, then a current descendant page exists that has not yet been processed by the loop that starts at block 905 and the current descendant page is not on a path that is a cycle, and the current descendant page contains a term 535 that matches a search keyword 305, so control continues to block 910 where the search engine 154 sets a total for the current page to zero.

Control then continues to block 915 where the search engine 154 enters a loop that executes once for each term 535 in the current descendant page that matches a search keyword 305. So long as the current descendant page includes a current term that matches a search keyword 305 and the current term has not yet been processed by the loop that starts at block 915, control continues to block 920 where the search engine 154 sets the current page total to be the current page total plus the weight 540 in the index 152 that is assigned to the current term in the current page. Control then returns to block 915 where the search engine 154 sets the current matching term 535 to be the next matching term 535 in the current page 138 and determines whether all matching terms 535 in the current page 138 have been processed.

Once all matching terms 535 for the current page 138 have been processed, the loop that starts at block 915 is done, so control continues from block 915 to block 925 where the search engine 154 sets the match score for the current page to be the current page total that was calculated by the loop that started at block 915 multiplied by the page popularity 525 of the current page. The current page match score thus indicates, in an embodiment, the relative degree to which the current page includes terms 535 that match the search keywords 305, the relative degree to which the terms 535 in the current page are important within the current page, and/or the relative degree to which the current page is popular or important as compared to other pages that are described by the index 152.

Control then continues to block 930 where the search engine 154 determines whether the current page match score is greater than a match threshold value. In an embodiment, the match threshold value is zero, meaning that a page containing even one term that matches the keyword 305 is relevant, regardless of the location of the term within the current page and regardless of the unpopularity of the current page. In other embodiments, the match threshold may be fixed or variable. For example, in an embodiment, the search engine changes the match threshold in proportion to the number of descendant pages of the root page are found, in proportion to the number of descendant pages of the root page that include a term that matches the keyword are found, in proportion to the number of child links in the root page, in proportion to the number of paths from each, some, or all of the child links, or based on any other appropriate criteria. The search engine may change the match threshold, in order to adjust the number of relevant paths and direct descendant links to a level that is manageable and useful for the user.

If the determination at block 930 is true, then the current page match score is greater than a match threshold value, so control continues from block 930 to block 935 where the search engine 154 sets the page relevancy for the current page to be true. Control then returns to block 905 where the search engine 154 sets the current page to be the next found descendant page that is on a path that is not a cycle and includes a term 535 that matches a search keyword 305, as previously described above.

If the determination at block 930 is false, then the current page match score is not greater than the match threshold, so control returns from block 930 to block 905, as previously described above.

When all descendant pages of the root page 315 that are described in the index 152 and that are on a path from the root page 315 and that is not on a cycle and that include a term 535 that matches the received search keyword 305 have been processed by the loop that starts at block 905, then the loop is done, so control continues from block 905 to block 999 where the logic of FIG. 9 returns.

Although embodiments of the invention have been described above as being implemented by a search engine at a server computer system, another embodiment of the invention may be implemented by the browser 190, such as in a browser toolbar function that performs both the search submission and the markup of the root page. A browser toolbar is a type of browser extension that adds additional buttons to the browser interface to accomplish certain tasks. In such a case, the root page and the extra information about the links may come from different sources, and the toolbar merges the information on the client computer system in a way that the browser 190 can display. For example, if the browser 190 displays a root page, and the user decides to search (via the toolbar) for near pages that contain a keyword, the toolbar submits the request to the server, but the toolbar only retrieves the descendant link information (not the modified version of the root page). Then the toolbar locally re-renders the root page to include the search result information.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving an identifier of a root page, a keyword, and a depth from a client;
searching a plurality of descendant pages for the keyword, wherein the searching further comprises searching the plurality of descendant pages that are at a plurality of levels from the root page, and wherein the plurality of levels are within the depth;
finding a term in a first descendant page that matches the keyword; and
sending a copy of the root page and a descendant link that points at the first descendant page to the client.

2. The method of claim 1, wherein the sending further comprises:
adding the descendant link into the copy of the root page.

3. The method of claim 1, wherein the sending further comprises:
adding the descendant link into a results page; and
sending the results page to the client.

4. The method of claim 1, further comprising:
finding a child link in the root page, wherein the child link points at a child page of the root page;
determining a path relevancy for the child link, wherein the determining further comprises determining a plurality of page relevancies for each of the descendant pages in a path of the child link and performing a logical-or of the plurality of page relevancies; and
sending the path relevancy for the path of the child link to the client.

5. The method of claim 4, further comprising:
adding the path relevancy for the child link to the copy of the root page.

6. The method of claim 4, further comprising:
assigning a color to the path relevancy.

7. The method of claim 4, further comprising:
sending a description of the path to the client.

8. The method of claim 4, wherein the determining the plurality of page relevancies for each of the descendant pages further comprises:
determining a match score for the keyword with respect to each of the descendant pages; and
sending the match score for the first descendant page to the client.

9. The method of claim 4, wherein the determining further comprises:
determining whether the child page comprises the first descendant page; and
if the child page comprises the first descendant page, adding an indication that the child link is directly relevant to the copy of the root page.

10. The method of claim 9, further comprising:
if the child page is different from the first descendant page, adding an indication that the child link is indirectly relevant to the copy of the root page.

11. A method for deploying computing services, comprising:
integrating computer readable code into a computer system, wherein the code in combination with the computer system performs the method of claim 1.

12. A signal-bearing medium encoded with instructions, wherein the instructions when executed comprise:
receiving an identifier of a root page, a keyword, and a depth from a client;
searching a plurality of descendant pages for the keyword, wherein the searching further comprises searching the plurality of descendant pages that are at a plurality of levels from the root page, and wherein the plurality of levels are within the depth;
finding a term in a first descendant page that matches the keyword;
adding a descendant link that points at the first descendant page into a copy of the root page; and
sending the copy of the root page to the first descendant page to the client.

13. The signal-bearing medium of claim 12, further comprising:
finding a child link in the root page, wherein the child link points at a child page of the root page;
determining a path relevancy for the child link, wherein the determining further comprises determining a plurality of page relevancies for each of the descendant pages in a path of the child link and performing a logical-or of the plurality of page relevancies; and
adding the path relevancy for the child link to the copy of the root page.

14. The signal-bearing medium of claim 13, further comprising:
adding a description of the path to the copy of the root page.

15. The signal-bearing medium of claim 14, wherein the determining the plurality of page relevancies for each of the descendant pages further comprises:
determining a match score for the keyword with respect to each of the descendant pages; and
adding the match score for the first descendant page to the copy of the root page.

16. The signal-bearing medium of claim 15, wherein the determining further comprises:
determining whether the child page comprises the first descendant page;
if the child page comprises the first descendant page, adding an indication that the child link is directly relevant to the copy of the root page; and
if the child page is different from the first descendant page, adding an indication that the child link is indirectly relevant to the copy of the root page.

17. A computer system comprising:
a processor; and
memory connected to the processor, wherein the memory encodes instructions that when executed by the processor comprise:
receiving an identifier of a root page, a keyword, and a depth from a client,
searching a plurality of descendant pages for the keyword, wherein the searching further comprises searching the plurality of descendant pages that are at a plurality of levels from the root page, and wherein the plurality of levels are within the depth,
finding a term in a first descendant page that matches the keyword,
adding a descendant link that points at the first descendant page into a copy of the root page, and
sending the copy of the root page to the first descendant page to the client.

18. The computer system of claim 17, wherein the instructions further comprise:
finding a child link in the root page, wherein the child link points at a child page of the root page;
determining a path relevancy for the child link, wherein the determining further comprises determining a plurality of page relevancies for each of the descendant pages in a path of the child link and performing a logical-or operation of the plurality of page relevancies, wherein the first descendant page is in the path; and
adding the path relevancy for the child link to the copy of the root page.

19. The computer system of claim 18, wherein the instructions further comprise:
adding a description of the path to the copy of the root page.

20. The computer system of claim 18, wherein the determining the plurality of page relevancies for each of the descendant pages further comprises:
determining a match score for the keyword with respect to each of the descendant pages; and
adding the match score for the first descendant page to the copy of the root page.
